(19) United States
(12) Patent Application Publication
(10) Pub. No.: US 2011/0032553 A1
(43) Pub. Date: Feb. 10, 2011

(54) COLOR MATERIAL AMOUNT DETERMINATION TABLE FORMING METHOD AND COLOR MATERIAL AMOUNT MEASUREMENT APPARATUS

(76) Inventor: Kazuki FUNAHASHI, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/850,145

(22) Filed: Aug. 4, 2010

(30) Foreign Application Priority Data
Aug. 7, 2009 (JP) 2009-184341
Jul. 8, 2010 (JP) 2010-155829

(51) Int. Cl. H04N 1/60

(52) U.S. Cl. 358/1.9

(57) ABSTRACT

A disclosed color material amount determination table forming method includes forming a pattern image by changing a control parameter controlling the adhered amount of plural color materials so that the adhered amounts of the respective color materials are changed in the pattern image, measuring reflectance characteristics in a visible wavelength region and an infrared wavelength region of the pattern image; calculating the color value of the pattern image; calculating the adhered amounts of the respective color materials in the pattern image, and forming the color material amount determination table in which the color value of the multi-colored image is associated with the respective adhered amounts of the color materials.

### CROSS-REFERENCE TO RELATED APPLICATIONS

The present application claims priority under 35 U.S.C §119 based on Japanese Patent Application Nos. 2009-184341 filed Aug. 7, 2009 and 2010-155829 filed Jul. 8, 2010, the entire contents of which are hereby incorporated herein by reference.

### BACKGROUND OF THE INVENTION

1. Field of the Invention

The present invention generally relates to a color material amount determination table forming method and a color material amount measurement apparatus for measuring amounts of color materials adhered on an image formed by an image forming apparatus forming a color image using plural color materials, the image forming apparatus including a color laser printer, a color inkjet printer and the like.

2. Description of the Related Art

In general image forming apparatuses such as digital color copiers, laser printers, color inkjet printers and the like, an image is formed by fixing (adhering) plural color materials having different spectral characteristics from each other such as cyan (C), magenta (M), yellow (Y), and black (K) on a recording medium. A color forming a solid image without being mixed with any other color material may be called a single color or primary color. On the other hand, multi-colors formed by mixing two or more color materials for forming an image may be called a secondary color, tertiary color, quadratic color and the like depending on the number of mixed color materials. An image formed by an image forming apparatus includes various multi-colors expressed (determined) by changing (adjusting) adhered amounts of the color materials of CMYK and an image area rate of the image.

As a method of detecting the adhered amounts of the respective color materials on an image formed by an image forming apparatus, a method is proposed which is based on a fact that the reflection characteristics of images change depending on the adhered amount of the color material. Therefore, in this method, the reflection characteristics of the images are previously associated with the respective adhered amounts of the color materials. Then, the adhered amount is obtained by measuring the reflection characteristics of the image and using the associated relationships between the reflection characteristics of the images and the respective adhered amounts of the color materials.

There are two main methods of associating the reflection characteristics of the images and the respective adhered amounts of the color materials.

In one main method, a prediction model is prepared and used to predict (estimate) reflection characteristics based on the adhered amount of the color material. The prediction model is typically obtained by using the Kubelka-Munk theory, the Williams-Clapper theory or the like. In the Kubelka-Munk theory, a differential equation is derived based on the transmittance and the diffusivity of the color material and the reflectance of the sheet, and then, the reflectance of the incident light is calculated. On the other hand, in the Williams-Clapper theory, the reflectance is calculated by performing ray-tracing of the phenomenon of the multiple reflections of the incident light in the layer of the color material of the image. In either of the methods, it is possible to obtain the reflectance of the color material based on the adhered amount of the color material on the image once such a prediction model is prepared (formed) by previously measuring the transmittance characteristics of the color material, the reflectance of the recording medium and the like.

Japanese Patent Application Publication No. 2001-356052 (Patent Document 1) discloses a method of obtaining the adhered amount of the color material by associating the reflection characteristics of the images and the respective adhered amounts of the color materials using the prediction model. In this method of Patent Document 1, the adhered amount of the color material is obtained by measuring a color value L*a*b* of the image and calculating the adhered amount of each of the color materials using the Kubelka-Munk theory, the adhered amount of each of the color materials realizing a color closest to the color of the color value L*a*b*.

However, practically, the Kubelka-Munk theory and the Williams-Clapper theory are likely to be satisfied only when the conditions of the image are ideal. Because of this feature, when the adhered amounts of the respective color materials are calculated, there may be a case where the differences between the predicted values of the reflectance and the color value and the measured values of the reflectance and the color value, respectively, become large, thereby increasing the errors depending on the conditions of the image. Namely, it may become difficult to stably and highly accurately obtain the adhered amount of each of the color materials for the entire images. Further, in the method of Patent Document 1, in order to obtain (determine) the color closest to the color of the color value L*a*b* of the image, it may be necessary to repeatedly calculate the color value L*a*b* while changing the combination of the color materials and the adhered amounts. Because of this feature, it may take a longer time period to determine the adhered amount of each of the color materials. Especially, when the number of patches to be measured is large or when the distribution of the adhered amount of each of the color materials is required to be calculated, the longer time period necessary to determine the adhered amount of each of the color materials may become a serious problem.

On the other hand, in the other main method of associating the reflection characteristics of the images with the respective adhered amounts of the color materials, there has been proposed that a table be provided that is generated based on the measured values of the reflection characteristics of the images and the adhered amount of each of the color materials. Then, by using the table, the reflection characteristics of the images are associated with the respective adhered amounts of the color materials. In this method of using the table to associate the reflection characteristics of the images with the respective adhered amounts of the color materials, it is required to actually measure the reflection characteristics of the images and the adhered amount of each of the color materials. However, when compared with the method of using the prediction model, once the table is generated, the adhered amount of each of the color materials may be calculated faster because the adhered amount of each of the color materials can be obtained simply by referring to the table based on the measured value of the reflection characteristics of the images.

For example, Japanese Patent Application Publication No. 2009-71617 (Patent Document 2) discloses this method of using the table in which the reflection characteristics of the images are associated with the adhered amount of each of the color materials. More specifically, in Patent Document 2, to calibrate the gamma and the color conversion parameters, a variability characteristics table is generated that associates the adhered amount of each of the color materials for the primary colors with the spectral density. Then, using the variability characteristics table, the adhered amounts of the respective color materials are estimated based on the spectral density converted from the spectral reflectance measured value of a primary colored patch. According to this method, it is stated that the plural spectral densities of the various adhered amounts of the respective color materials are measured (determined) for a large single wavelength range from 400 nm to 700 nm or for each of plural ranges from the divided large wavelength range from 400 nm to 700 nm. Then, by using the spectral densities of the determined wavelength, the adhered amount of each of the color materials can be highly accurately estimated.

Further, Japanese Patent Application Publication No. 2000-338742 (Patent Document 3) proposes a method of deriving the toner adhered amount of a single color or multi-colors by irradiating a light having an emission spectrum in the infrared wavelength region onto the image on the intermediate transfer body to maintain the color balance and detecting the reflected light using a density sensor. This method is characterized by generating a table in which the sensor output signal levels are associated with the toner adhered amount by using a characteristic where the reflected light intensity of toner in the infrared wavelength region does not depend on the color materials and the toner adhered amount, and then calculating the adhered amount of each of the color materials of a predetermined pattern.

However, in the method of Patent Document 2, the variability characteristics table is generated in which the adhered amount of the color material is associated with the spectral density for the primary colors only. Because of the limitation, it may be possible to calculate the adhered amounts of the color materials of the primary colors, but it may be difficult to calculate the adhered amount of the color materials of multi-colors formed by mixing plural color materials together. When considering that the multi-colors are normally used in a colored image formed by an image forming apparatus, it may be inconvenient if the adhered amounts of the color materials for only primary colors can be calculated, because applicable cases may be remarkably limited.

When an effort is made to generate the table in which the adhered amounts of the respective color materials are associated with the spectral density for the multi-colors in the same method as described above, much efforts and a very long time period may be required to set the adhered amount of each of the color materials and perform measurements. As a result, it may be practically difficult to generate the table for the multi-colors based on this method. Further, when the adhered amount of the color material is calculated using the spectral density, it is required to obtain the spectral reflectance of the image and accordingly, a measurement apparatus having a function of separating a reflected light from the image into its spectral components is required. In this case, the cost of the measurement apparatus becomes higher than that of a general reflected light measurement apparatus such as the RGB sensor.

Further, in the method of Patent Document 3, it may become possible to calculate the entire adhered amount of the various combined color materials of multi-colors similar to the case of the primary color based on the relationships between the sensor output signal levels and the toner adhered amounts by using a characteristic where the reflected light intensity does not depend on the types of the color materials.

However, on the other hand, even when the adhered amount is obtained, it is not possible to determine whether the adhered amount is based on the primary color or the multi-colors. As a result, it may not possible to determine the adhered amount of each of the color materials of a multi-colored image of a single patch. Because of this limitation, the images and patterns may be limited from which the adhered amount of each of the color materials can be calculated.

### SUMMARY OF THE INVENTION

As described above, as the method of detecting the adhered amount of each of the color materials, there are known methods of calculating the adhered amount of each of the color materials by associating the reflection characteristics of the images with the adhered amount of each of the color materials by using the prediction model or the table.

However, in the method using the prediction model, the error between the result obtained based on the prediction model and the measurement value is likely to become larger and it takes much time to determine the adhered amount of each of the color materials.

On the other hand, in the method using the table, once the table is prepared, a highly accurate adhered amount of each of the color materials may be calculated within a short time period. However, it may not be possible to determine the adhered amount of each of the color materials when the image is multi-colored such as a secondary color, a tertiary color or the like.

The present invention is made in light of the above circumstances and may provide a color material amount determination table forming method of measuring the adhered amount of each of the color materials based on a color value of an arbitrary multi-colored image, and a color material amount measurement apparatus for measuring color material amounts using the color material amount determination table formed by the color material amount determination table forming method.

According to an aspect of the present invention, there is provided a color material amount determination table forming method of forming a color material amount determination table in which a color value of a multi-colored image is associated with respective adhered amounts of color materials, the multi-colored image being formed by an image forming apparatus.

This color material amount determination table forming method includes a pattern image output step of forming a pattern image on a recording medium by changing a control parameter controlling the adhered amount of each of the color materials used in the image forming apparatus so that the adhered amount of each of the color materials is changed in the pattern image, a reflectance characteristics measurement step of measuring reflectance characteristics in a visible wavelength region and an infrared wavelength region of the pattern image, a color value calculation step of calculating the color value of the pattern image based on the reflectance characteristics in the visible wavelength region measured in the reflectance characteristics measurement step, a color material amount calculation step of calculating the adhered amount of each of the color materials in the pattern image based on the reflectance characteristics in the infrared wavelength region measured in the reflectance characteristics measurement step; and a table forming step of forming the color material amount determination table in which the color value of the multi-colored image is associated with the respective adhered amounts of the color materials, the multi-colored image being formed by the image forming apparatus, the color material amount determination table being formed based on the color value calculated in the color value calculation step and the adhered amount of each of the color materials calculated in the color material amount calculation step.

In the color material amount determination table forming method according to this aspect of the present invention, a predetermined solid image pattern including multi-colors is formed on the recording medium by changing the adhered amount of each of the color materials. From the solid image pattern, color values are obtained from the reflectance characteristics in the visible wavelength region and the adhered amounts of the respective color materials are calculated from the reflectance characteristics in the infrared wavelength region. Then, the color material amount determination table is formed in which the color value in the multi-colored image is associated with the respective adhered amounts of the color materials. Because of this association between the color value in the multi-colored image and the respective adhered amounts of the color materials, when the color value of an arbitrary multi-colored image is obtained, the adhered amount of each of the color materials may be obtained by referring to the color material amount determination table.

Further, the color value and the adhered amounts are actually measured. When compared with the method using a prediction model, the color value may be more accurately associated with the respective adhered amounts.

Further, the color value may be obtained by using an inexpensive sensor. Further, when an image input apparatus such as a scanner and camera is used, two-dimensional color value data may be obtained. Therefore, it may become possible to select the apparatus to measure the reflected light from more choices.

### BRIEF DESCRIPTION OF THE DRAWINGS

Other objects, features, and advantages of the present invention will become more apparent from the following description when read in conjunction with the accompanying drawings, in which:

FIG. 1 is a block diagram illustrating an entire configuration of a table forming system according to a first embodiment of the present invention;

FIG. 2 is a cross-sectional drawing schematically illustrating a configuration of a printer according to the first embodiment of the present invention;

FIG. 3 is a schematic drawing illustrating a configuration of a reflectance characteristic measurement apparatus according to the first embodiment of the present invention;

FIG. 4 is a schematic drawing illustrating grid points in three-dimensional adhered amount space;

FIG. 5 is a flowchart illustrating a process of forming a color material amount determination table according to the first embodiment of the present invention;

FIG. 6 is a drawing illustrating a reference pattern image according to the first embodiment of the present invention;

FIG. 7 is a drawing illustrating an adhered amount control process according to the first embodiment of the present invention;

FIG. 8 is a drawing illustrating a pattern image according to the first embodiment of the present invention;

FIG. 9 is a drawing illustrating an example of a color material amount determination table;

FIG. 10 is a drawing illustrating an entire configuration of a color material amount measurement system according to a second embodiment of the present invention;

FIG. 11 is a flowchart illustrating a color material amount calculation process according to the second embodiment of the present invention;

FIG. 12 is a schematic drawing illustrating a configuration of a color measurement section according to a third embodiment of the present invention;

FIG. 13 is a flowchart illustrating a color material amount calculation process according to the third embodiment of the present invention; and

FIG. 14 is a flowchart illustrating a detailed color material amount calculation process according to the third embodiment of the present invention.

### DETAILED DESCRIPTION OF THE PREFERRED EMBODIMENTS

According to an embodiment of the present invention, there is provided a color material amount determination table forming method of forming a color material amount determination table in which a color value of a multi-colored image is associated with respective adhered amounts of color materials, the multi-colored image being formed by an image forming apparatus. The color material amount determination table forming method includes a pattern image output step of forming a pattern image on a recording medium by changing a control parameter controlling the adhered amount of the respective color materials used in the image forming apparatus so that the adhered amounts of the respective color materials are changed in the pattern image, a reflectance characteristics measurement step of measuring reflectance characteristics in a visible wavelength region and an infrared wavelength region of the pattern image, a color value calculation step of calculating the color value of the pattern image based on the reflectance characteristics in the visible wavelength region measured in the reflectance characteristics measurement step, a color material amount calculation step of calculating the adhered amounts of the respective color materials in the pattern image based on the reflectance characteristics in the infrared wavelength region measured in the reflectance characteristics measurement step, and a table forming step of forming the color material amount determination table in which the color value of the multi-colored image is associated with the respective adhered amounts of the color materials, the multi-colored image being formed by the image forming apparatus, the color material amount determination table being formed based on the color value calculated in the color value calculation step and the adhered amounts of the respective color materials calculated in the color material amount calculation step.

Before the description of the embodiments of the present invention, the terms of “multi-colored image”, “single-colored image”, “color image”, and “monochrome image” are described.

The term “multi-colored image” herein refers to an image formed on a recording medium and formed by using multi-colors (i.e., two or more colors from among a group of colors such as CMYK). An image generally used in color printing corresponds to this “multi-colored image”.

The term “single-colored image” herein refers to an image formed on a recording medium and formed by using a single color (i.e., only one color from among a group of colors such as CMYK). An image generally used in monochrome printing (generally, only K is used) corresponds to this “single-colored image”.

The term “color image” herein refers to a digital image having pixels, each of the pixels being expressed by using values expressing the corresponding colors such as RGB. A normal digital color image corresponds to this “color image”.

The term “monochrome image” herein refers to a digital image having pixels, each of the pixels being expressed by using a single value for the gray scale (darkness) of the pixel. A normal digital monochrome (gray-scale) image corresponds to this “monochrome image”.

Therefore, a term “color image of a multi-colored image” described below refers to a digital image having pixels, each of the pixels having values obtained by the image forming apparatus, pixel by pixel, based on the corresponding values (such as RGB values) of an image formed on a recording medium. A normal digital color image formed on color printing corresponds to this “color image of a multi-colored image”.

Next, a color material amount determination table forming method according to an embodiment of the present invention and a color material amount measurement apparatus measuring a color material amount using a color material amount determination table formed by the color material amount determination table forming method are described with reference to the accompanying drawings.

In the embodiments of the present invention, from technical points of view, various preferable limitations may be added to the configurations of the present invention as preferred embodiments of the present invention. However, unless otherwise described to limit the invention in the descriptions below, the scope of the present invention is not limited to the embodiments described below.

### First Embodiment

According to a first embodiment of the present invention, there is provided the color material amount determination table forming method of forming the color material amount determination table in which the color values of an image formed by the image forming apparatus are associated with the respective adhered amounts of the color materials.

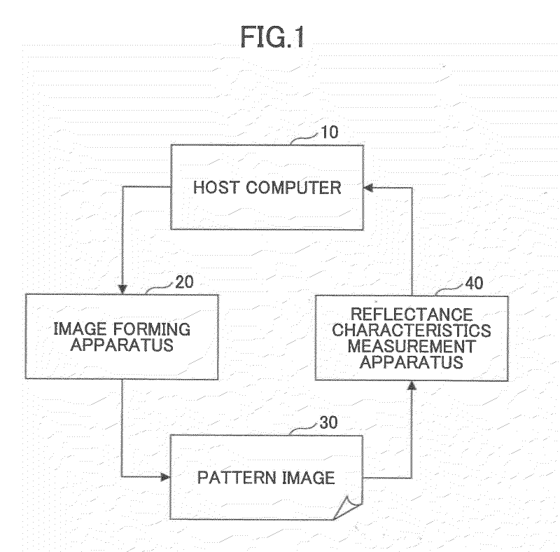

FIG. 1 schematically illustrates an entire configuration of a table forming system that realizes the color material amount determination table forming method according to this first embodiment of the present invention. As shown in FIG. 1, this table forming system includes a host computer 10, an image forming apparatus 20 outputting a pattern image 30, and a reflectance characteristics measurement apparatus 40.

The host computer 10 is a host device of the image forming apparatus 20 and the reflectance characteristics measurement apparatus 40. The host computer 10 transmits image data (pattern image data) and adhered amount control processing data (control parameter data) stored in the host computer 10 to a controller of the image forming apparatus 20, and gives an instruction to form an image. Further, the host computer 10 controls the operations of the reflectance characteristics measurement apparatus 40 and stores the data measured by the reflectance characteristics measurement apparatus 40.

The image forming apparatus 20 may be a copier, a laser printer, an inkjet printer or the like, and inputs image data and fixes the color materials onto a recording medium based on the input data so that the image is formed on the recording medium. In this first embodiment, as an example, a full-color laser beam printer is described in which four colors of toner (i.e., yellow (Y), cyan (C), magenta (M), and black (K)) are used to be fixed onto the recording medium.

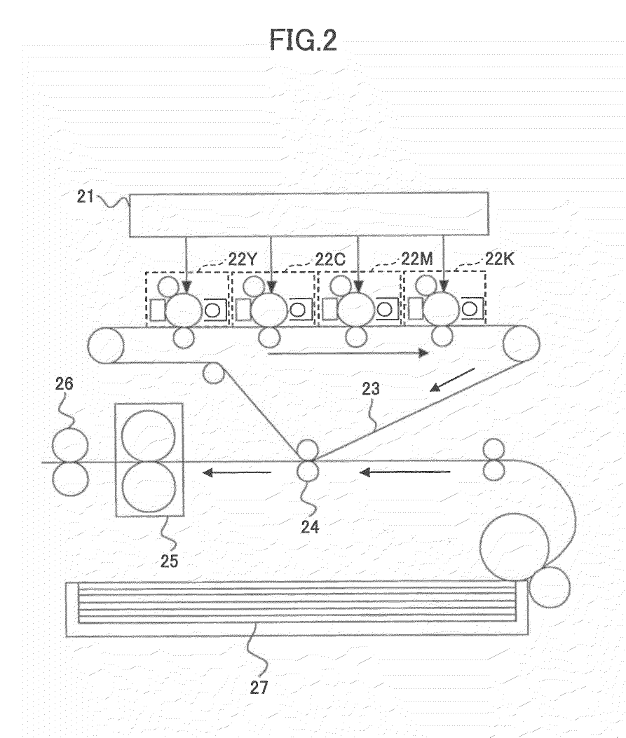

FIG. 2 illustrates a schematic configuration of the image forming apparatus 20 according to this first embodiment of the present invention. As illustrated in FIG. 2, the image forming apparatus 20 includes a laser optical unit 21, photosensitive body units 22Y, 22C, 22M, and 22K corresponding to the respective YCMK colors, an intermediate transfer belt 23, transfer rollers 24, a fixing unit 25, discharge rollers 26, and a paper feeding unit 27. The photosensitive body units are arranged from the upstream side to the downstream side in the order of 22Y, 22C, 22M, and 22K. Each of the photosensitive body units 22Y, 22C, 22M, and 22K includes a photosensitive drum serving as a latent image carrier; a charger unit for charging the photosensitive drum to a predetermined voltage; a development unit for developing the electrostatic latent image, using toner, formed on the photosensitive drum; and a cleaner for collecting toner remaining on the photosensitive drum after the transfer process.

Next, an image forming process performed by the image forming apparatus 20 is described.

First, the photosensitive drums of the photosensitive body units 22Y, 22C, 22M, and 22K are uniformly charged at a predetermined voltage. The laser optical unit 21 exposes the photosensitive drums charged based on the image data input to the image forming apparatus 20, so that latent images are formed on the surfaces of the photosensitive drums. Based on the latent images, the respective color toner images are developed by the development units, and sequentially superposed onto the intermediate transfer belt 23 in the order of Y, C, M, and K so as to be transferred from the respective photosensitive drums. The superposed image transferred onto the intermediate transfer belt 23 is further transferred onto the recording medium (recording paper) between the transfer rollers 24, the recording medium being fed from the paper feeding unit 27. Then, the recording medium is heated and pressed in the fixing unit 25 so that the toner images on the recording medium is accordingly fixed. Then, the recording medium is discharged by the discharge rollers 26 to a discharge tray (not shown).

The reflectance characteristics measurement apparatus 40 measures the reflectance characteristics of the pattern image 30. More specifically, the reflectance characteristics measurement apparatus 40 measures RGB values of the reflected light in a visible wavelength region, the reflected-light RGB values corresponding to three colors which are red (R), green (G), and blue (B) and being used to calculate a color value. Further, the reflectance characteristics measurement apparatus 40 measures reflected light in an infrared wavelength region to calculate the adhered amounts of the respective color materials.

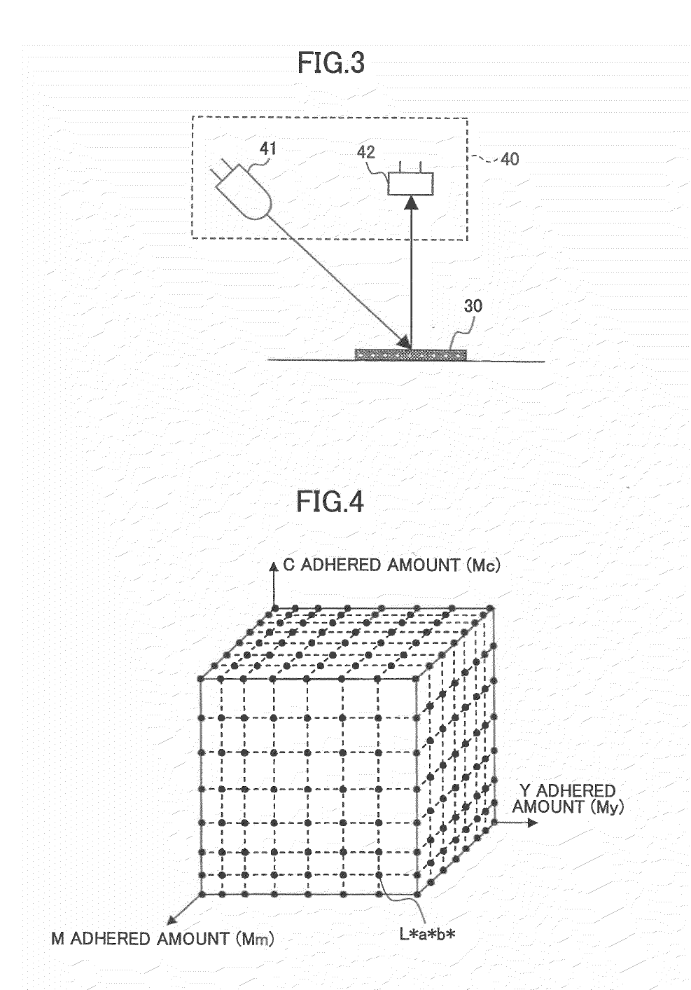

FIG. 3 illustrates a schematic configuration of a measurement section of the reflectance characteristics measurement apparatus 40. As illustrated in FIG. 3, the measurement section of the reflectance characteristics measurement apparatus 40 includes a light source 41 and a light receiving sensor 42. The light source 41 irradiates the pattern image 30. The light receiving sensor 42 detects the reflected light from the pattern image 30.

When the reflected light in the visible wavelength region is measured, a light receiving sensor having sensitivity in the visible wavelength region and a light source having radiance in the visible wavelength region are jointly used. In this case, for example, a white-color LED may be used as the light source 41, and an RGB color sensor in which color filters corresponding to red (R), green (G), and blue (B) colors are formed on a photodiode chip may also be used as the light receiving sensor 42. Otherwise, the RGB values of the reflected light may be measured by using an RGB three color LED as the light source 41 together with a sensor having no color filter as the light receiving sensor 42. In this case, the color of the light is switched one by one from among three colors RGB, and the RGB values of the reflected light are sequentially measured.

In the following, a case is described where the RGB values of the reflected light from the pattern image are used as the measured values representing the reflectance characteristics in the visible wavelength region. However, the present invention is not limited to this configuration. Namely, any appropriate values other than the RGB values may alternatively be used as the measured values representing the reflectance characteristics in the visible wavelength region. Further, the configuration of the measurement section of the reflectance characteristics measurement apparatus 40 is not limited to the configuration as illustrated in FIG. 3. For example, alternatively, a spectroscope may be used to measure the spectral reflection factor in the visible wavelength region, so that the reflectance characteristics in the visible wavelength region are calculated based on the spectral reflection factor.

On the other hand, when the reflected light in the infrared wavelength region is measured, a light receiving sensor having sensitivity in the infrared wavelength region, specifically in the wavelength region where the transmissivities of the color materials are substantially equal to each other and a light source having radiance in the same wavelength region are jointly used. For example, an infrared LED and an infrared sensor may be used as the light source 41 and the light receiving sensor 42, respectively.

Preferably, the light source 41, the light receiving sensor 42, and the pattern image 30 are arranged in a manner such that a regularly reflected light component of the reflected light received by the light receiving sensor 42 is decreased. To that end, for example, as schematically illustrated in FIG. 3, a light from the light source 41 is incident on the pattern image 30 at an angle of 45 degrees with respect to the vertical axis, and the reflected light from the pattern image 30 is incident on the light receiving sensor 42 at an angle of 0 degree with respect to the vertical axis.

In the following, a procedure for forming the color material amount determination table is described in which the color values of a (multi-colored) image formed by the image forming apparatus are associated with the adhered amounts of the respective color materials of the colors used for forming the (multi-colored) image. In this first embodiment of the present invention, as an example, a procedure is described how to form the color material amount determination table used to calculate the adhered amounts of the respective color materials based on the color value of a multi-colored image formed by using up to three color materials of cyan, magenta, and yellow. In this example, the color value is obtained based on the measurement values of the reflected light in three wavelength regions of the RGB sensor and the like. On the other hand, the adhered amounts of the respective color materials are obtained based on the measurement values of the reflected light in one wavelength region. Because of those features, it is not required to use spectral data, which may make it possible to simplify the configuration of the reflectance characteristics measurement apparatus 40. Further, by increasing the number of times measuring the reflected light to obtain the color values and the adhered amounts of the respective color materials, it may become possible to improve the measurement accuracy.

FIG. 4 illustrates a three-dimensional adhered amount space and grid points. As illustrated in FIG. 4, the three-dimensional adhered amount space has three coordinate axes representing the respective adhered amounts of the color materials of cyan, magenta, and yellow. The grid points indicates respective specific adhered amounts of the color materials. The grid points correspond to the color values expressed as L*a*b* at the respective coordinate positions, the color values corresponding to the image formed at the respective coordinate positions by superposing the color materials of the colors. Therefore, the color material amount determination table is expressed as a three-dimensional matrix storing the adhered amounts and the L*a*b* values at the grid points in the three-dimensional adhered amount space.

In this case, it is not always necessary that the distances between the adjacent grid points are constant, and the distance may be adequately determined based on the distribution generated when the grid points are mapped into the L*a*b* space as described below. Further, in the first embodiment as illustrated in FIG. 4, the number of the grid points in each of adhered amount directions (i.e., each of the coordinate axes) of the respective color materials is eight (8). However, the present invention is not limited to this configuration. For example, the number of the grid points in each adhered amount direction may be less than or greater than eight (8). Further, the number of the grid points in an adhered amount direction may be different from that in any other adhered amount direction.

Herein, the terms “M adhered amount”, “Y adhered amount”, and “C adhered amount” refer to the adhered amounts of the color materials of magenta, yellow, and cyan, respectively. Further, the coordinate values of the “M adhered amount”, “Y adhered amount”, and “C adhered amount” are expressed as “Mm”, “My”, and “Mc”, respectively (as illustrated in FIG. 4). Further, the coordinate position of the grid point located at the “i-th” position in the “M adhered amount” direction, the “j-th” position in the “Y adhered amount” direction, and the “k-th” position in the “C adhered amount” direction is herein defined as (i,j,k). Further, the color value L*a*b* at the grid point at (i,j,k) is herein expressed as L(i,j,k), a (i,j,k), and b(i,j,k). Further, the “M adhered amount”, “Y adhered amount”, and “C adhered amount” of the grid point at (i,j,k) are herein expressed as “Mm(i)”, “My(j)”, and “Mc(k)”, respectively. However, hereinafter, the color value L*a*b* at the grid point at (i,j,k) may be collectively expressed (simplified) as Lab (i,j,k).

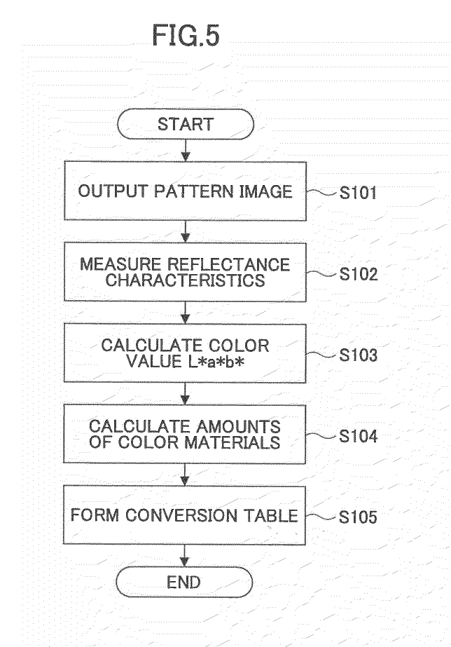

FIG. 5 is a flowchart illustrating a procedure how the color material amount determination table is formed.

In step S101, the image forming apparatus 20 forms (outputs) the pattern image 30 to be used for forming the color material amount determination table (pattern image output step). More specifically, the host computer 10 transmits a reference pattern image and the adhered amount control processing data (control parameter data) having been stored in the host computer 10 to the image forming apparatus 20, the adhered amount control processing data (control parameter data) describing a process of controlling the adhered amount in each patch of the reference pattern image. Based on the received reference pattern image and the adhered amount control processing data, the image forming apparatus 20 outputs the pattern image 30. The pattern image 30 has the same number of patches as that of the grid points set in the adhered amount space, so that the patches are formed based on the adhered amounts of the color materials at the corresponding grid points.

In the following, the grid points are divided into eight (8) planes expressed by Mc=Mc(k) (k=1,2, . . . , 8), and a procedure is described how the pattern image is formed on the plane where Mc=Mc(k).

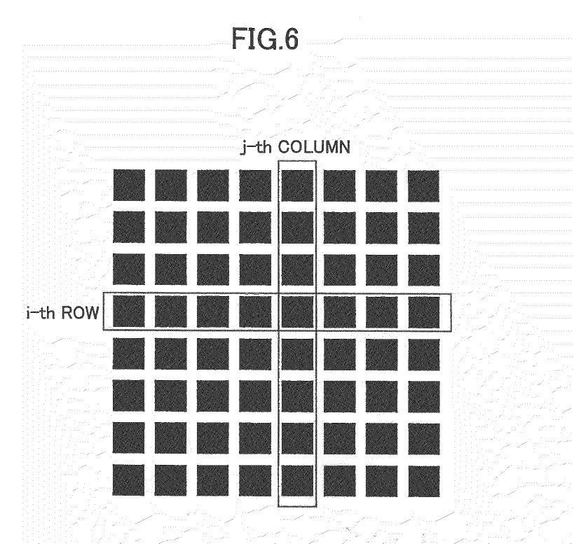

FIG. 6 shows a reference pattern image to be used for forming the pattern image on the plane where Mc=Mc(k). In FIG. 6, all patches are the same solid images where 100% of cyan, 100% of magenta, and 100% of yellow are input. By changing the adhered amounts of the respective color materials of the patches by performing an adhered amount control process described below, the patch images corresponding to the pattern image 30 are accordingly formed.

When the left-uppermost patch is defined as the reference patch, the patch located at i-th row and j-th column corresponds to the sample image at the grid point (i, j, k). However, corresponding relationship between the locations of the patches and the grid points is not limited to this example. Any appropriate corresponding relationship between the locations of the patches and the grid points may alternatively be used as long as the corresponding relationship has one-to-one relationship and the adhered amount control process described below can be applied. Further, the same pattern is applied to all the reference pattern images in all the planes where Mc=Mc(k) (k=1, 1, . . . , 8).

Among the patches of the reference pattern, the amounts of color materials are changed by performing the adhered amount control process for controlling the amounts of color materials. This adhered amount control process for controlling the amounts the color materials is performed by controlling the laser power to be used for writing the latent image onto the photosensitive bodies.

Herein, symbols “Lc”, “Lm”, and “Ly” are defined as the laser power for controlling (determining) the adhered amounts of cyan, magenta, and yellow materials, respectively. Further, herein, the “Lc” applied to each of the entire patches in the pattern image on the plane where Mc=Mc(k) is expressed as Lc(k); the “Lm” in the patch region at (i,j) is expressed as Lm(i); and the “Ly” in the patch region at (i,j) is expressed as Ly(j). In this case, the “Lc”, “Lm”, and “Ly” are controlled in a manner such that the larger “k”, “i”, and “j” become, the larger the “Lc”, “Lm”, and “Ly” become, respectively.

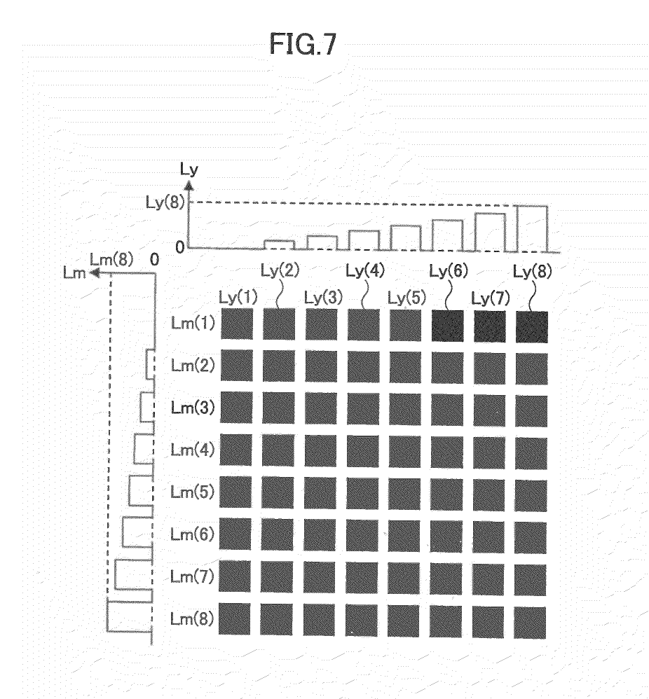

FIG. 7 shows a relationship between “Lm” and “Ly” in the reference pattern. However, FIG. 7 illustrates the status where all patches illustrated in FIG. 7 are the same solid images where 100% of cyan, 100% of magenta, and 100% of yellow are input, and does not illustrate the pattern image corresponding to the status where the laser powers Lc(k), Lm(i), and Ly(j) are applied.

In this case, it is desirable to set that when the laser powers are expressed as Lc(1), Lm(1), the laser powers are set to zero (0) and when the laser powers are expressed as Lc(8), Lm(8), and Ly(8), the adhered amounts of the cyan image, magenta image, and yellow images, respectively, are substantially the same as the maximum adhered amounts of the corresponding color materials realized in the image forming apparatus 20. In any region other than the patch regions, all laser powers Lc, Lm, and Ly are set to zero (0).

The host computer 10 transmits the reference pattern image data and the adhered amount control processing data (control parameter data) formed by the method described above to the image forming apparatus 20. Based on the transmitted reference pattern image data and the adhered amount control processing data (control parameter data), the pattern image of the plane where Mc=Mc(k) is formed on the recording medium. Further, by performing the same processes on each of the planes where Mc=Mc(k) (k=1, 2, . . . , 8), the pattern image 30 corresponding to the entire grid points in the in the adhered amount space is eventually formed.

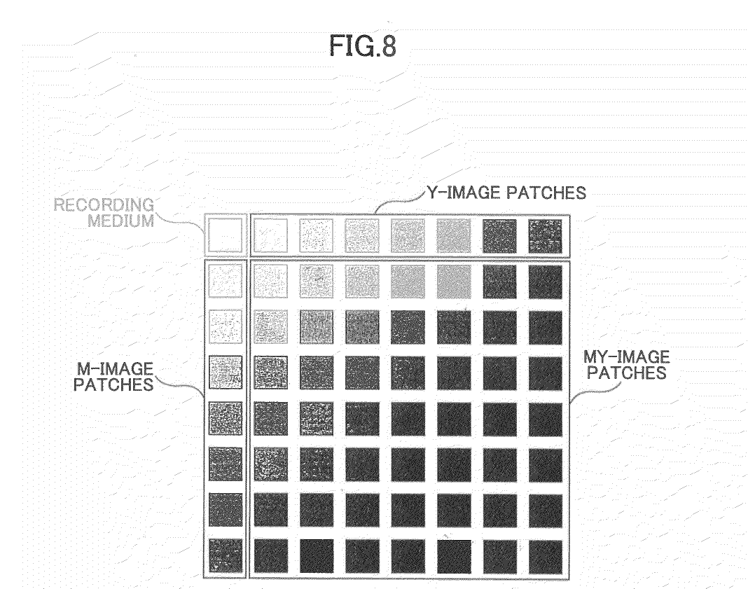

FIG. 8 illustrates the pattern image on the plane where Mc=Mc(1). In the pattern image of FIG. 8, the left-uppermost patch (1,1), the laser powers Lc, Lm, and Ly are set to zero (0). As a result, the left-uppermost patch (1,1) becomes the patch where none of the color materials of cyan, magenta, and yellow are developed. Further, in the patches of the first column, the power values Lc and Ly are set to zero (0). Therefore, those patches in the first column become M-image patches in which only magenta color material is developed except in the patch (1,1). Further, the adhered amount at the patch (i,l) corresponds to Mm(i). On the other hand, in the patches of the first row, the power values Lc and Lm are set to zero (0). Therefore, those patches in the first row become Y-image patches in which only yellow color material is developed except in the patch (1,1). Further, the adhered amount at the patch (1,j) corresponds to My(j). The rest of the patches become secondary colored MY-image patches in which both magenta and yellow color materials are superposed and developed. Therefore, the image is formed on the conditions that in the same row direction, the laser powers for magenta color are the same as each other, and that in the same column direction, the laser power for yellow color are the same as each other. As a result, the adhered amount of magenta color of the MY-image at patch (i.j) is equal to Mm(i) and the adhered amount of yellow color of the MY-image at patch (i.j) is equal to My(j). In the same manner, when the pattern image 30 is expressed in the three-dimensional adhered amount space where the positions of the patches corresponding to the grid positions are expressed as (i,j,k), the patches (1,1,k) except the patch (1,1,1) become C-image patches in which only cyan color material is developed. Further, the adhered amount at the patches (1,1,k) corresponds to Mc(k). Further, the adhered amounts of the color materials of magenta, yellow, and cyan in patch (i,j,k) are equal to Mn(i), My(j), and Mc(k), respectively. Because of this feature, by measuring the parts adhered amounts of the primary color patches (i.e., each of the patches where only primary color is adhered (developed)), it may become possible to obtain the adhered amounts of the colors for all the patches.

Further, in this first embodiment of the present invention, to output the pattern image in step S101, the laser power is controlled as illustrated in FIG. 7. In this case, the adhered amounts of the respective color materials is changed (adjusted) in a manner such that uniform laser power is applied to each of the entire single patch.

For example, to halve the adhered amount of the color material in a single patch, there may be another method in which a dot image (halftone image) having the half image area rate is used without changing the laser power.

However, as described above, in this first embodiment of the present invention, the laser power is controlled to form solid images (i.e., color materials are uniformly adhered to the respective entire parts of the patch), so that the adhered amounts of the color material are changed.

In the present invention, it is thought that the image formed on the recording medium by the image forming apparatus is made of sets of solid images each having a small area, and that the color values are associated with the respective adhered amounts of the color materials. By doing in this way, it may become possible to measure the adhered amount of the color materials in a small region and obtain a two-dimensional distribution of the adhered amounts of the respective color materials when the colored values of a target image are obtained by using an area CCD sensor or the like.

Further, in this first embodiment of the present invention, a case is described where the laser power is used as a control parameter to control (adjust) the adhered amounts of the respective color materials. However, the present invention is not limited to this configuration. For example, as the control parameter to control the adhered amounts of the respective color materials, the developing bias, the charger bias or the like may alternatively be used. For example, by changing the bias in the same page (recording medium), it may become possible to obtain the same pattern in which the adhered amounts of the respective color materials are changed in the same page (recording medium) as that formed by changing the laser power.

However, unlike the laser power that can be changed in two dimensions, the developing bias and the charger bias can be used to control in one-dimension only because of their control mechanism in which the bias is applied to the relevant roller only. Because of this limitation, when the developing bias or the charger bias is used, it may not be possible to arrange the patches in the two-dimension similar to the reference pattern of FIG. 6, and in other words, the patches are arranged in one line (direction). As a result, the number of patches formed within a single page (recording medium) may be reduced and the number of output pages may be accordingly increased when compared with the case where the laser power is used to form the table containing the same data.

Therefore, in this embodiment of the present invention, it is preferable that the laser power be used as the control parameter to control the adhered amounts of the respective color materials.

Referring back to FIG. 5, in next step S102, the reflectance characteristics measurement apparatus 40 measures the RGB values and the infrared reflected light of the pattern image 30 output from the image forming apparatus 20 (reflectance characteristics measurement step). As described above, in this step, the RGB values (i.e., reflectance characteristics in the visible wavelength region) are measured by using the light receiving sensor having sensitivity in the visible wavelength region together with the light source having radiance in the same wavelength region, and, on the other hand, the infrared reflected light (i.e., reflectance characteristics in the infrared wavelength region) is measured by using the light receiving sensor having sensitivity in the infrared wavelength region together with the light source having radiance in the same wavelength region.

In step S103, the RGB values measured in step S102 are converted into the color value L*a*b* which is independent of the apparatus (color value calculation step). As a method of converting from the RGB values into the color value L*a*b*, a conventional method used for color correction or the like may be used. For example, a correction pattern including plural patches having different color values is formed on a recording medium by the image forming apparatus 20, and the patches are measured by the reflectance characteristics measurement apparatus 40 and a spectrophotometer. Then, by using the RGB values of the correction pattern obtained from the reflectance characteristics measurement apparatus 40 and the XYZ values obtained from the spectrophotometer, a relational expression to be used for converting from the RGB values into the XYZ values is generated. Based on the generated relational expression, the RGB values measured by the reflectance characteristics measurement apparatus 40 nay be converted into the XYZ values. Then, the color value L*a*b* is calculated. In this step S103, the color values Lab(i,j,k) of the grid points are obtained.

In step S504, based on the infrared reflected light measured in step S102, the adhered amounts of color materials Mc(k), Mm(i), and My(j) at each of the grid points are calculated (color material amount calculation step). To calculate the adhered amounts, a previously prepared table is used in which the relationship is described between the output signal levels from the infrared sensor and the corresponding adhered amounts. In the infrared wavelength region where the infrared sensor is used for detection, the transmissivities of cyan, magenta, and yellow colors are not dependent on the type of the color materials, but the output signal from the infrared sensor depends on the sum of the adhered amounts of the color materials. Therefore, a table is formed that indicates the relationship between the measured adhered amounts of plural color materials and the output signal from the infrared sensor based on the measurements of the adhered amounts of the respective color materials on the patches formed on the recording medium and the infrared reflected light while the parameter such as the laser power or the developing bias of the image forming apparatus 20 is changed, the parameter being for controlling the adhered amounts of the respective color materials. In this case, the values of the adhered amounts of the respective color materials between the measured output signal are interpolated by performing the linear interpolation or the spline interpolation between the measured values when necessary.

In step S105, the color material amount determination table is formed based on the color values L*a*b* of the grid points calculated in step S103 and the adhered amounts of the respective color materials of the grid points calculated in step S104 (table forming step). The color material amount determination table is expressed in a three-dimensional matrix form where pointers to the L*a*b* corresponding to the respective grid positions are stored in the cells and where the respective data indicating the adhered amounts of color materials of CMY colors are added.

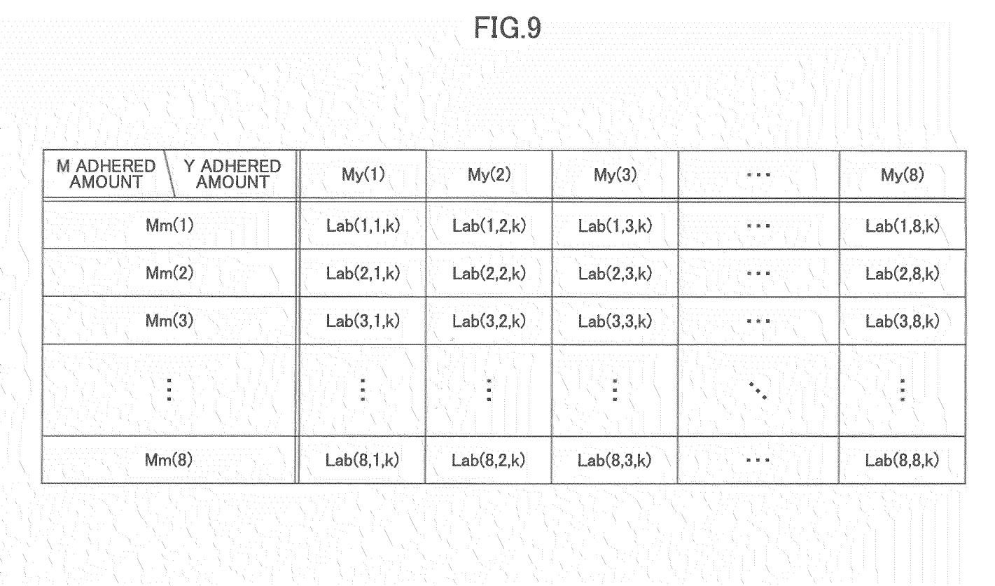

FIG. 9 shows an example of the color material amount determination table on the plane where Mc=Mc(k).

Based on the procedure as described above, the color material amount determination table may be formed. In a case where the adhered amounts of the respective color materials are actually calculated, the interpolation such as spline interpolation may be applied to the values of the adhered amounts or the color values L*a*b* between the cells of the color material amount determination table on an as-needed basis.

Based on the color material amount determination table forming method as described in this first embodiment of the present invention, the color material amount determination table in which the color values of a multi-colored image are associated with the respective adhered amounts of the color materials may be formed. Because of this feature, when the color values of an arbitrary multi-colored image are obtained, the adhered amounts of the respective color materials are separately obtained by referring to the color material amount determination table. Further, the color values and the adhered amounts are actually measured. Because of this feature, when compared with the method in which relationships are obtained based on the prediction model, the color values and the adhered amounts may be more accurately associated with each other. Further, the laser power (control parameter) is used to perform the adhered amount control within the same recording medium (the same page) based on a prescribed rule. Because of this feature, it may become possible to reduce the time period required to output and measure the pattern image.

Further, the color values may be obtained by using an inexpensive sensor, and when an image forming apparatus such as a scanner, a camera or the like is used, two-dimensional color value data may be obtained. Therefore, it may become possible to select the apparatus measuring the reflected light from more choices.

### Second Embodiment

In the following, a second embodiment of the present invention is described. In the second embodiment, a color material amount measurement apparatus is disclosed that calculates adhered amounts of the respective color materials of a multi-colored image based on the color material amount determination table formed by the color material amount determination table forming method according to the first embodiment of the present invention.

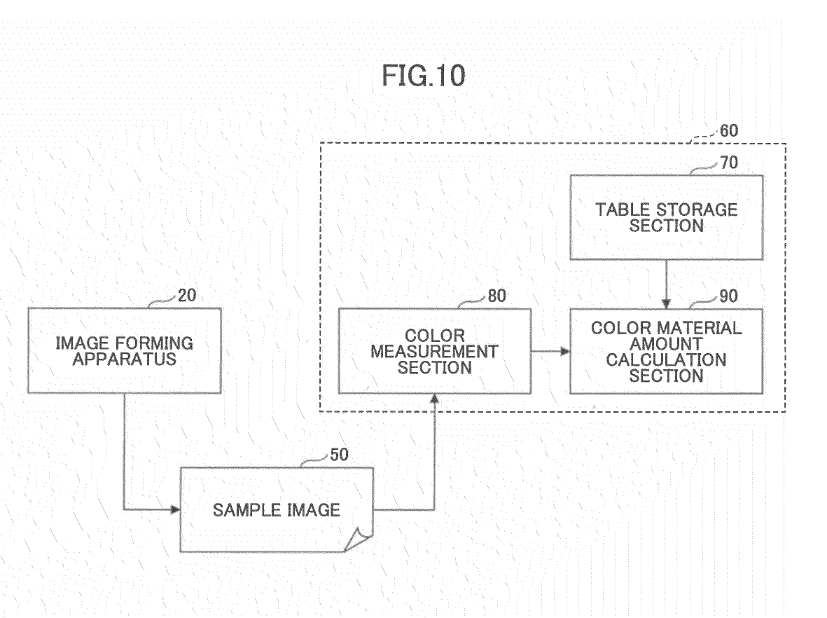

FIG. 10 schematically illustrates an entire configuration of a color material amount measurement system according to this second embodiment of the present invention. As illustrated in FIG. 10, the color material amount measurement system includes the image forming apparatus 20 and a color material amount measurement apparatus 60. The image forming apparatus 20 outputs a sample image (multi-colored image) 50.

The image forming apparatus 20 fixes the color materials on a recording medium and forms the image based on the image data. The image forming apparatus 20 may be a copier, a laser printer, an inkjet printer or the like. In this second embodiment, similar to the first embodiment, it is assumed that the image forming apparatus 20 is a full-color laser beam printer that forms an image by fixing the four color toner (i.e., yellow (Y), cyan (C), magenta (M), and black (K)) on a recording medium.

As described above, the sample image (multi-colored image) 50 is formed by the image forming apparatus 20, there is no limitation about the types and the adhered amounts of the respective color materials.

As illustrated in FIG. 10, the color material amount measurement apparatus 60 includes a table storage section (table storage unit) 70, a color measurement section (color value acquisition unit) 80, and a color material amount calculation section (color material amount determination unit) 90. By having this configuration, the color material amount measurement apparatus 60 calculates the adhered amounts of the respective color materials of the colors on the sample image (multi-colored image) 50 formed by the image forming apparatus 20.

The table storage section 70 stores the color material amount determination table in which the color values L*a*b* of the image are associated with the respective adhered amounts of color materials, the color material amount determination table having been formed in advance based on the color material amount determination table forming method according to the first embodiment of the present invention. Further, in this second embodiment of the present invention, it is assumed that table storage section 70 has already stored at least the color material amount determination table formed under the same image forming conditions as those of the sample image (multi-colored image) 50.

Further, preferably, the table storage section 70 has already stored plural color material amount determination tables formed under the plural (different) image forming conditions. Further, preferably, the color material amount calculation section 90 described below calculates the adhered amounts of color materials of a multi-colored image on the recording medium based on one color material amount determination table corresponding to the image forming condition of the multi-colored image. In this case, this color material amount determination table is selected from among the plural color material amount determination tables formed under the plural (different) image forming conditions.

When the image forming apparatus or a type of the paper (recording medium) is changed, the color values may be changed even when the same colors (color materials) with the same adhered amounts of the respective color materials are output to the image. Even in this case, the color material amount measurement apparatus 60 may calculate the adhered amounts of the respective color materials based on the color material amount determination table that is formed under the corresponding (or the same) image forming conditions. Because of this feature, it may become possible to stably and accurately calculate the adhered amounts of the respective color materials. Further, it may become possible to prevent the interruption caused by preparing a table every time when the image forming conditions are changed.

The color measurement section 80 measures the RGB values (reflectance characteristics in the visible wavelength region) of the sample image (multi-colored image) 50. Similar to the measurement section of the reflectance characteristics measurement apparatus 40, the color measurement section 80 includes the light source and the light receiving sensor. In this case, for example, a white-color LED may be used as the light source, and an RGB color sensor in which color filters corresponding to red (R), green (G), and blue (B) colors are formed on a photodiode chip may be used as the light receiving sensor.

The color material amount calculation section 90 calculates the adhered amounts of color materials of the colors based on the color material amount determination table using the RGB values, the color material amount determination table having been stored in the table storage section 70, the RGB values having been measured by the color measurement section 80. Then, the color material amount calculation section 90 outputs the calculated adhered amounts of color materials.

In the following, a procedure is described how to calculate the adhered amounts of the respective color materials on the sample image.

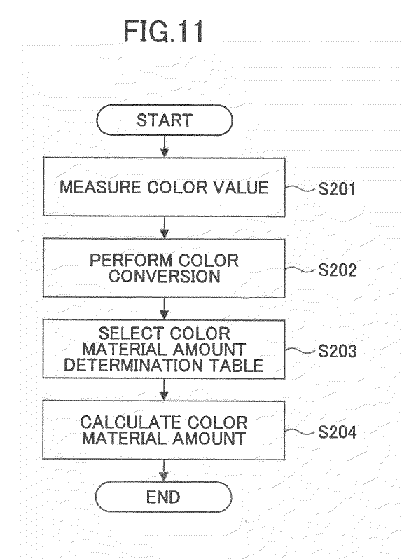

FIG. 11 is a flowchart illustrating the procedure how to calculate the adhered amounts of the respective color materials according to this second embodiment of the present invention.

First, in step S201, the RGB values are measured. More specifically, the color measurement section 80 measures the RGB values of the sample image (multi-colored image) 50 formed by the image forming apparatus 20.

In step S202, the RGB values measured in step S201 are converted into the color value L*a*b* which is independent of the apparatus. As the method of converting from the RGB values into the color value L*a*b*, a method described in the above first embodiment of the present invention may be used.

In step S203, an appropriate color material amount determination table is selected. In this case, a user (operator) may select a color material amount determination table which is formed under the same image forming conditions as those for the sample image (multi-colored image) 50 from among one or more color material amount determination tables stored in the table storage section 70.

In step S204, the adhered amounts of the respective color materials are calculated based on the color value L*a*b* of the sample image (multi-colored image) 50 calculated in step S202 and the color material amount determination table selected in step S203. More specifically, first, the coordinate position on the color material amount determination table of the color value L*a*b* of the sample image is determined. When determining the coordinate position of the color value L*a*b*, an interpolation such as the spline interpolation may be performed on the color values L*a*b* between the cells of the color material amount determination table on an as-needed basis. Further, a color difference value ΔE between the color value L*a*b* of the sample image and the color value on the color material amount determination table is calculated. Then, the coordinate position is determined where the color difference value ΔE from the color value L*a*b* of the sample image is minimized. In the L*a*b* color system, the color difference value ΔE between the two points (L0*, a0*, b0*) and (L1*, a1*, b1*) is obtained based on the following formula (1).

ΔE=\sqrt{(L0*−L1*)²+(a0*−a1*)²+(b0*−b1*)²} formula (1)

Next, the adhered amounts of the respective color materials corresponding to the coordinate position where the color difference value ΔE is minimized is read out from the color material amount determination table. By doing in this way, the adhered amounts of the respective color materials may be determined.

According to the procedure described above, it may become possible to determine the adhered amounts of the respective color materials of the colors adhered (used) in the image based on the color values of the sample image. In the reflectance characteristics measurement apparatus according to this second embodiment of the present invention, the color material amount determination table having been formed and stored is used. Because of this feature, it may become possible to calculate the adhered amounts of the respective color materials in a short time period. Further, as described above, in the color material amount determination table according to the embodiment of the present invention may also be applied to a multi-colored image so that the color values of the image are associated with the corresponding adhered amounts of the color materials in the color material amount determination table. Because of this feature, it may become possible to determine the adhered amounts of the respective color materials for not only a primary color image but also a multi-colored image. Further, the adhered amounts of the respective color materials are calculated based on the color values of the image. Because of this feature, there are many choices in selecting a sensor to measure the color values and accordingly, an inexpensive sensor may be used.

### Third Embodiment

In the following, a color material amount measurement apparatus according to a third embodiment of the present invention is described. The color material amount measurement apparatus according to this third embodiment of the present invention calculates a two-dimensional adhered amount distribution of each of the color materials of the sample image based on the color material amount determination table formed by the method described in the first embodiment of the present invention. An entire configuration of a color material amount measurement system according to this third embodiment of the present invention is similar to that described in FIG. 10, except that a configuration of the color measurement section 80 is different from that in the second embodiment and the process performed in the color material amount calculation section 90 is different from that in the second embodiment.

The color measurement section 80 in this third embodiment of the present invention measures the two-dimensional distribution of the color values of the sample image (multi-colored image) 50.

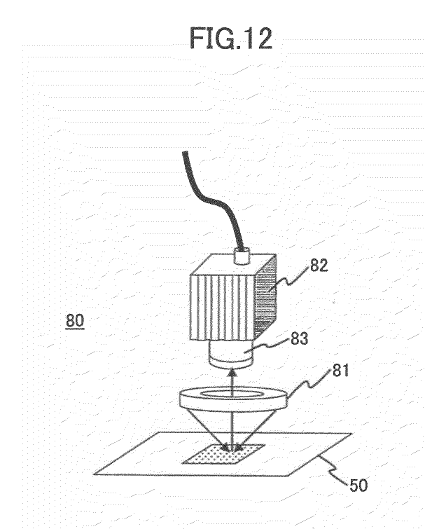

FIG. 12 illustrates an exemplary configuration of the color measurement section 80. As illustrated in FIG. 12, the color measurement section 80 includes a ring-shaped white color LED light source 81, a color CCD camera 82, and a lens 83. In this configuration, a light irradiated from the light source 81 is reflected by the sample image (multi-colored image) 50, so that the image is formed on an area CCD senor in the color CCD camera 82 by the lens 83. As a result, an RGB image including RGB values of the pixels is obtained. By using this configuration, two-dimensional color value distribution of the sample image (multi-colored image) 50 corresponding to the image region may be measured. It should be noted that the configuration of the color measurement section 80 is not limited to this configuration. For example, another image input apparatus (image input device) such as a scanner and a camera may alternatively be used to acquire image data, and any image data other than RGB may alternatively be used.

In the image input apparatus, the two-dimensional color value information of the image may be obtained. By applying the color material amount determination tables to the corresponding color values of the pixels, it may become possible to calculate two-dimensional adhered amount distribution in accordance with the acquired region and the resolution of the image. Because of this feature, it may become possible to calculate the adhered amounts by performing a single measurement even for plural patches. Further, it may become possible to detect the change of the adhered amounts within the same patch. Because of this feature, more detailed analysis may further be performed.

In the following, a procedure how to calculate the two-dimensional adhered amount distribution of the sample image is described.

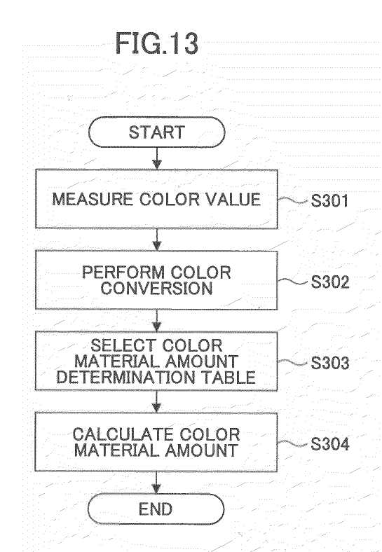

FIG. 13 is a flowchart illustrating a color material amount calculation procedure according to this third embodiment of the present invention.

First, in step S301, the color measurement section 80 measures the sample image (multi-colored image) 50 formed by the image forming apparatus 20 to acquire the image. In this case, the area CCD sensor receives the reflected light from the sample image. As a result, the RGB image including RGB values of the pixels may be obtained. Namely, two-dimensional image data corresponding to the image shooting area and the resolution of the color CCD camera 82 are obtained.

In step S302, the RGB values (color image) measured in step S301 are converted into the color value L*a*b* which is independent of the apparatus. As the method of converting from the RGB values into the color value L*a*b*, a method described in the above first embodiment of the present invention may be used.

In step S303, an appropriate color material amount determination table is selected. In this case, a user (operator) may select a color material amount determination table which is formed under the corresponding image forming conditions of the sample image (multi-colored image) 50 from among one or more color material amount determination tables stored in the table storage section 70.

In step S304, a two-dimensional adhered amount distribution of each of the color materials on the sample image is obtained based on the color value L*a*b* of the sample image (multi-colored image) 50 calculated in step S302 and the color material amount determination table selected in step S303.

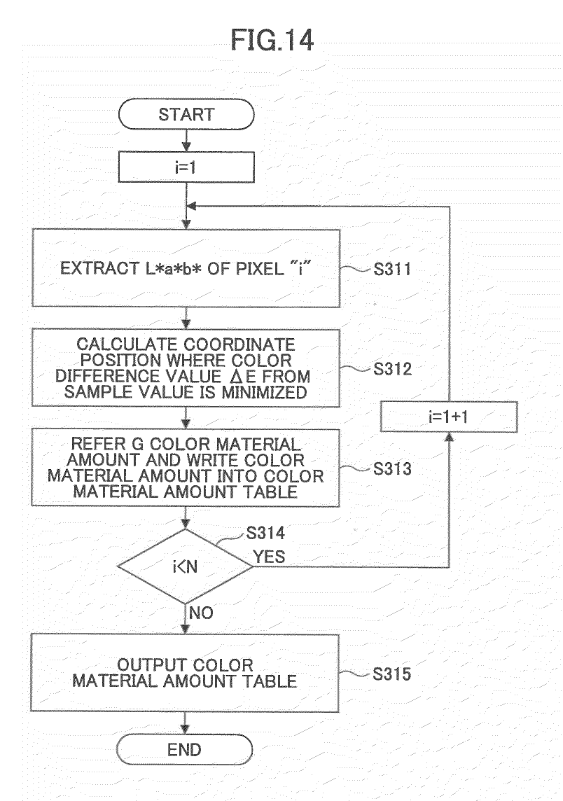

FIG. 14 is a flowchart illustrating a detailed procedure how to calculate the adhered amount calculation in this step S304.

First, numbers are assigned to all the pixels of the L*a*b* image of the sample image (multi-colored image) 50, so that the pixel number is expressed using “i”. The following process is performed on a certain pixel “i”.

In step S311, the color value L*a*b* in pixel “i” is extracted.

In step S312, the coordinate position of the color material amount determination table is calculated where the color difference value ΔE from the color value L*a*b* of the sample image is minimized. In this calculation, similar to the above second embodiment, the interpolation such as the spline interpolation may be performed on the color values L*a*b* between the cells of the color material amount determination table on an as-needed basis. Then the above color difference values ΔE are calculated and the coordinate position is determined where the color difference values ΔE are minimized.

Next, in step S313, the adhered amount of each of the color materials corresponding to the coordinate position calculated in step S312 is referred to and written into a corresponding color material amount table. The color material amount table refers to a matrix having the same number of cells as that of the pixels of the sample image. The data of the adhered amount of each of the color materials obtained from the color value of the pixel “i” are stored in the cell corresponding to the pixel “i”.

In step S314, it is determined whether the calculation of the adhered amounts for all the pixels has been completed. When determining that the calculation for all the pixels has not yet been completed, the process goes back to step S311 to repeat the steps S311 through 5313 for the next pixel “i+1”.

On the other hand, in step S314, when determining that the calculation of the adhered amounts for all the pixels has been completed, the process goes to step S315, where the formed color material amount table is output. In the cells of this color material amount table, the adhered amount of each of the color materials corresponding to the pixel positions is stored. Because of this feature, the two-dimensional adhered amount distribution of each of the color materials may be obtained.

By performing the procedure the two-dimensional adhered amount distribution of each of the color materials corresponding to the shooting area and the resolution of the RGB image may be obtained.

Further, according to any of the first through the third embodiments of the present invention, the color value which is independent of the apparatus is used. Because of this feature, it may become possible to accurately measure the adhered amounts of the respective color materials regardless of the measurement apparatus measuring the color value.

According to an embodiment of the present invention, there is provided a color material amount determination table forming method of forming a color material amount determination table in which a color value of a multi-colored image is associated with respective adhered amounts of color materials, the multi-colored image being formed by an image forming apparatus.

This color material amount determination table forming method includes a pattern image output step of forming a pattern image on a recording medium by changing a control parameter controlling the adhered amounts of the respective color materials used in the image forming apparatus so that the adhered amounts of the respective color materials are changed in the pattern image, a reflectance characteristics measurement step of measuring reflectance characteristics in a visible wavelength region and an infrared wavelength region of the pattern image, a color value calculation step of calculating the color value of the pattern image based on the reflectance characteristics in the visible wavelength region measured in the reflectance characteristics measurement step, a color material amount calculation step of calculating the adhered amounts of the respective color materials in the pattern image based on the reflectance characteristics in the infrared wavelength region measured in the reflectance characteristics measurement step; and a table forming step of forming the color material amount determination table in which the color value of the multi-colored image is associated with the respective adhered amounts of the color materials, the multi-colored image being formed by the image forming apparatus, the color material amount determination table being formed based on the color value calculated in the color value calculation step and the adhered amounts of the respective color materials calculated in the color material amount calculation step.

In the color material amount determination table forming method according to this embodiment of the present invention, a predetermined solid image pattern including multi-colors is formed on the recording medium by changing the adhered amounts of the respective color materials. From the solid image pattern, color values are obtained from the reflectance characteristics in the visible wavelength region and the adhered amounts of the respective color materials are calculated from the reflectance characteristics in the infrared wavelength region. Then, the color material amount determination table is formed in which the color value in the multi-colored image is associated with the respective adhered amounts of the color materials. Because of this association between the color value in the multi-colored image and the respective adhered amounts of the color materials, when the color value of an arbitrary multi-colored image is obtained, the adhered amounts of the respective color materials may be obtained by referring to the color material amount determination table.

Further, the color value and the adhered amounts are actually measured. When compared with the method using a prediction model, the color value may be more accurately associated with the respective adhered amounts.

Further, the color value may be obtained by using an inexpensive sensor. Further, when an image input apparatus such as a scanner and camera is used, two-dimensional color value data may be obtained. Therefore, it may become possible to select the apparatus to measure the reflected light from more choices.

Further, the pattern image output in the pattern image output step may be formed by changing the control parameter controlling the adhered amounts of the respective color materials within the same recording medium.

By having this feature, it may become possible to change the adhered amounts of the respective color materials among the patches in the same recording medium (paper) by changing the control parameter controlling the adhered amounts of the respective colored materials in the same recording medium. As a result, it may become possible to reduce the number of pattern image sheets and also reduce the time period required to output images and measure the reflectance characteristics.

Further, in the reflectance characteristics measurement step, a reflected light may be measured in at least three wavelength regions in the visible wavelength region and the reflected light may be measured in at least one wavelength region in the infrared wavelength region.

By measuring in this way, it may become possible to simplify the configuration of the reflectance characteristics measurement apparatus because it is not necessary to have any measurement apparatus for measuring spectral data. Further, by increasing the number of times measuring the reflected light to obtain the color values and the adhered amounts of the respective color materials, it may become possible to improve the measurement accuracy.

According to an embodiment of the present invention, a color material amount measurement apparatus is provided that calculates the adhered amounts of the respective color materials in a multi-colored image formed by the image forming apparatus.

The color material amount measurement apparatus includes a table storage unit configured to store a color material amount determination table formed by the color material amount determination table forming method as described above, a color value acquisition unit configured to acquire the color value of the multi-colored image, and a color material amount determination unit configured to convert the color value acquired by the color value acquisition unit into the adhered amounts of the respective color materials based on the color material amount determination table stored in the table storage unit.

By having this configuration, the color material amount determination table stored in advance is used. Therefore, the adhered amounts of the respective color materials may be calculated in a short time period. Further, as described above, in the color material amount determination table, the color values are associated with the respective adhered amounts of the color materials. Because of this feature, the adhered amount(s) of the color material(s) in not only a single color image but also a multi-colored image may be calculated. Further, the adhered amounts are calculated from the color values. Because of this feature, there may be many choices in selecting a sensor to measure the color values and accordingly, an inexpensive sensor may be used.

Further, the color material amount determination tables may be formed for respective plural image forming conditions, and the color material amount determination unit may calculate the adhered amounts of the respective color materials based on the color material amount determination table corresponding to the image forming conditions of the multi-colored image.

By having this configuration, it may become possible to store the color material amount determination tables corresponding to the image forming conditions including, for example, the type of color materials and the type of sheets. By doing this, the color material amount determination table adapted to image data may be selected to accurately calculate the adhered amounts of the respective color materials in the image data.

Generally, when the image forming apparatus or the sheet (type of sheet) is changed, even though the same color material and the same adhered amount are set to form an image, the color value of the formed image may be changed. Even in such a case, in the color material amount measurement apparatus according to an embodiment of the present invention, the adhered amounts of the respective color material may be calculated by using the color material amount determination table formed in the corresponding image forming condition. Because of this feature, it may become possible to stably and accurately calculate the adhered amounts of the respective color materials. Further, it may become possible to prevent the interruption caused by preparing a table every time when the image forming condition is changed.

Further, the color value acquisition unit may acquire a color image of the multi-colored image using an image input apparatus and acquire the color value based on values of pixels of the acquired color image.

Further, the conversion from the color value into the adhered amounts of the respective color materials performed by the color material amount determination unit may be performed for each of the pixels of the colored image, and two-dimensional adhered amount distribution of each of the color materials corresponding to a region of the acquired colored image may be calculated.

To that end, an image input apparatus is used to measure the color value of the image as the color measurement section. The image input apparatus may provide two-dimensional color value information. Therefore, by using the color material amount determination table for the color value of the corresponding pixels, it may become possible to calculate the two-dimensional adhered amount distribution corresponding to the acquired region and the resolution of the image. Because of this feature, it may become possible to calculate the adhered amounts by performing a single measurement even for plural patches. Further, it may become possible to detect the change of the adhered amounts within the same patch. Because of this feature, more detailed analysis may further be performed.

Further, in the color material amount determination table forming method described above, as the color value, a converted value which is independent of the image forming apparatus may be used.

By using the color value which is a converted value independent of the image forming apparatus, it may become possible to perform highly accurately color material amount measurement without depending on the measurement apparatus for measuring the color value.

Further, in the color material amount measurement apparatus described above, the color value may be a converted value which is independent of the image forming apparatus.

By using the color value which is a converted value independent of the image forming apparatus, it may become possible to perform highly accurately color material amount measurement without depending on the measurement apparatus for measuring the color value.

According to an embodiment of the present invention, there are provided a color material amount determination table forming method of measuring the adhered amounts of the respective color materials based on a color value of an arbitrary multi-colored image and a color material amount measurement apparatus for measuring color material amounts using the color material amount determination table formed by the color material amount determination table forming method.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A color material amount determination table forming method of forming a color material amount determination table in which a color value of a multi-colored image is associated with respective adhered amounts of plural color materials, the multi-colored image being formed by an image forming apparatus, the method comprising:
a pattern image output step of forming a pattern image on a recording medium by changing a control parameter controlling the adhered amounts of the respective color materials used in the image forming apparatus so that the adhered amounts of the respective color materials are changed in the pattern image;
a reflectance characteristics measurement step of measuring reflectance characteristics in a visible wavelength region and an infrared wavelength region of the pattern image;
a color value calculation step of calculating the color value of the pattern image based on the reflectance characteristics in the visible wavelength region measured in the reflectance characteristics measurement step;
a color material amount calculation step of calculating the adhered amounts of the respective color materials in the pattern image based on the reflectance characteristics in the infrared wavelength region measured in the reflectance characteristics measurement step; and
a table forming step of forming the color material amount determination table in which the color value of the multi-colored image is associated with the respective adhered amounts of the color materials, the multi-colored image being formed by the image forming apparatus, the color material amount determination table being formed based on the color value calculated in the color value calculation step and the adhered amounts of the respective color materials calculated in the color material amount calculation step.

2. The color material amount determination table forming method according to claim 1, wherein
the pattern image output in the pattern image output step is formed by changing the control parameter controlling the adhered amount of the respective color materials within a same recording medium.

3. The color material amount determination table forming method according to claim 1, wherein
in the reflectance characteristics measurement step, a reflected light is measured in at least three wavelength regions in the visible wavelength region and the reflected light is measured in at least one wavelength region in the infrared wavelength region.

4. A color material amount measurement apparatus calculating adhered amounts of plural color materials in a multi-colored image formed by an image forming apparatus, the color material amount measurement apparatus comprising:
a table storage unit configured to store a color material amount determination table formed by the color material amount determination table forming method according to claim 1;
a color value acquisition unit configured to acquire the color value of the multi-colored image; and
a color material amount determination unit configured to convert the color value acquired by the color value acquisition unit into the adhered amounts of the respective color materials based on the color material amount determination table stored in the table storage unit.

5. The color material amount measurement apparatus according to claim 4, wherein
the color material amount determination table is formed for plural image forming conditions, and
the color material amount determination unit calculates the adhered amount of the respective color materials based on the color material amount determination table corresponding to the image forming condition of the multi-colored image.

6. The color material amount measurement apparatus according to claim 4, wherein
the color value acquisition unit acquires a color image of the multi-colored image using an image input apparatus and acquires the color value based on values of pixels of the acquired color image.

7. The color material amount measurement apparatus according to claim 6, wherein
the conversion from the color value into the adhered amount of the respective color materials performed by the color material amount determination unit is performed for each of the pixels of the colored image, and a two-dimensional adhered amount distribution of the respective color materials corresponding to a region of the acquired colored image is calculated.

8. The color material amount determination table forming method according to claim 1, wherein
the color value is a converted value which is independent of the image forming apparatus.

9. The color material amount measurement apparatus according to claim 4, wherein
the color value is a converted value which is independent of the image forming apparatus.
